(19) United States
(12) Patent Application Publication
(10) Pub. No.: US 2007/0285771 A1
(43) Pub. Date: Dec. 13, 2007

(54) Endoscope system

(75) Inventor: Masaya Nakaoka, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/804,084

(22) Filed: May 17, 2007

(30) Foreign Application Priority Data
May 29, 2006 (JP) 2006-148040

(51) Int. Cl. G02B 21/06

(52) U.S. Cl. 359/389

(57) ABSTRACT

Observation using a plurality of types of light having different spectrum characteristics is enabled while reducing the diameter of an insertion section of an endoscope, acquisition of a plurality of types of image which is applied with arithmetic processing with respect to each other and is displayed in a superimposed manner, so that the observation accuracy is improved. There is provided an endoscope system that acquires images of an object to be observed in a body cavity of a living body by being introduced at least partly into the body cavity including: a light source that emits a plurality of types of irradiation light having different spectral characteristics and being radiated onto the object to be observed; an optical system that propagates the irradiation light from the light source toward the object to be observed; an image pickup device which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light; a variable spectroscopic device which is arranged in an optical path between the image pickup device and the distal end of the portion to be inserted into the body cavity and is capable of changing the wavelength band of light entering the image pickup device from the object to be observed by varying the spectral characteristics thereof; and a controller that controls the light source, the variable spectroscopic device, and the image pickup device so as to acquire an image of the fluorescent light in a plurality of the wavelength bands and of the light different in wavelength band from the fluorescent light at the same position in a time-sharing manner.

### BACKGROUND OF THE INVENTION

1. Field of the Invention

The present invention relates to an endoscope system.

This application is based on Japanese Patent Application No. 2006-148040, the content of which is incorporated herein by reference.

2. Description of Related Art

In an endoscope observation of a living body using an endoscope system, it is preferable to employ an observation method using a plurality of types of light having different spectral characteristics in order to observe the state of the living body with high degree of accuracy.

There is an endoscope which enables the observation using the plurality of types of light having different spectral characteristics which is disclosed, for example, in the Publication of Japanese patent no. 2802061.

The endoscope disclosed in the Publication of Japanese patent no. 2802061 employs a variable spectroscopic element in which the transmittance characteristics may be varied in an optical system of the endoscope.

However, the endoscope disclosed in the Publication of Japanese patent no. 2802061 simply picks up light in different wavelength bands to acquire an image and presents the same. Therefore, there is a problem such that the acquired images of a plurality of types are displaced or varied in distance, so that it is difficult to perform arithmetic processing or superimposing display with respect to each other as it were. In order to solve this problem, it is necessary to perform, for example, a complex image blurring collection, so that there arises a disadvantage such that the system becomes complicated.

### BRIEF SUMMARY OF THE INVENTION

The invention provides following means.

A first aspect of the invention is an endoscope system that acquires images of an object to be observed in a body cavity of a living body by being introduced at least partly into the body cavity including: a light source that emits a plurality of types of irradiation light having different spectral characteristics and being radiated onto the object to be observed, an optical system that propagates the irradiation light from the light source toward the object to be observed; an image pickup device which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light; a variable spectroscopic device which is arranged in an optical path between the image pickup device and the distal end of the portion to be inserted into the body cavity and is capable of changing the wavelength band of light entering the image pickup device from the object to be observed by varying the spectral characteristics thereof, and a controller that controls the light source, the variable spectroscopic device, and the image pickup device so as to acquire an image of the fluorescent light in a plurality of the wavelength bands and of the light different in wavelength band from the fluorescent light at the same position in a time-sharing manner.

A second aspect of the invention is an endoscope system that acquires images of an object to be observed in a body cavity of a living body by being introduced at least partly into the body cavity including: a light source that emits a plurality of types of irradiation light having different spectral characteristics and being radiated onto the object to be observed; an optical system that propagates the irradiation light from the light source toward the object to be observed; an image pickup device which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light; a spectrum forming device which is arranged in an optical path between the image pickup device and the distal end of the portion to be inserted into the body cavity and spatially forming spectrum of light incoming from the object to be observed into the image pickup device; and a controller that controls the light source and the image pickup device so as to acquire an image of the fluorescent light in a plurality of the wavelength bands and of the light different in wavelength band from the fluorescent light substantially at the same time.

In the first and second aspects of the invention, the spectrum forming device may be a plurality of optical filters being arranged next to the image pickup device on the upstream side and having different wavelength characteristics.

In the first and second aspects of the invention, images of the fluorescent light in the plurality of wavelength bands and the light different in wavelength band from the fluorescent light may be picked up before the image pickup device moves relatively with respect to the object to be observed under the control of the controller.

In the first and second aspects of the invention, images of the fluorescent light in the plurality of wavelength bands and the light different in wavelength band from the fluorescent light may be picked up continuously under the control of the controller.

In the invention described above, an image arithmetic processing unit that performs arithmetic processing among a plurality of fluorescent images acquired by picking up images of the fluorescent light in the plurality of wavelength bands may be provided.

In the first and second aspects of the invention, a display that displays images after having applied with the arithmetic processing by the image arithmetic processing unit may be provided.

In the first and second aspects of the invention, the fluorescent light in the plurality of wavelength bands may be generated by exciting a plurality of fluorescent substances by irradiation light in one or more wavelength bands.

In the first and second aspects of the invention, at least one of the fluorescent light in the plurality of wavelength bands may be fluorescent light in a wavelength band from red to near-infrared emitted by fluorescent agent combined with a specific substance existing in the interior of the object to be observed or fluorescent agent accumulated in the interior of the object to be observed being excited by the irradiation light.

In the first and second aspects of the invention, the light different in wavelength band from the fluorescent light may be reflected light from the object to be observed in a visible band.

In the first and second aspects of the invention, at least one of the fluorescent light in the plurality of wavelength bands may be fluorescent light emitted from a substance originally existing in the interior of the object to be observed by being excited by the irradiation light.

In the first aspect of the invention, the variable spectroscopic device may have a first state which allows the fluorescent light in at least one wavelength band included in fluorescent light emitted from the object to be observed to enter the image pickup device and a second state which prevents the fluorescent light of the corresponding wavelength band from entering the image pickup device.

In the first aspect of the invention, the variable spectroscopic device may have the first state which allows fluorescent light in a first wavelength band from fluorescent light emitted from the object to be observed to enter the image pickup device and prevents fluorescent light in a second wavelength band different from the first wavelength band from entering the image pickup device, the second state which prevents the fluorescent light in the first wavelength band and the second wavelength band from entering the image pickup device, and a third state which prevents the fluorescent light in the first wavelength band from entering the image pickup device and allows the fluorescent light in the second wavelength band to enter the image pickup device.

In the first aspect of the invention, the variable spectroscopic device may have a transmitting band common to the spectrum characteristics in all the states.

In the first and second aspects of the invention, the common transmitting band may include at least part of a wavelength band from green to blue in a visible band including red, green and blue.

In the first aspect of the invention, the controller may switch the plurality of types of irradiation light emitted from the light source in a time-sharing manner.

In the first aspect of the invention, the controller may perform switching of the irradiation light emitted from the light source and switching of the spectrum characteristics of the variable spectroscopic device.

In the first and second aspects of the invention, the controller may control an exposure value of the image pickup device by adjusting light from the light sources or adjusting the exposure of the image pickup device according to the switching of the irradiation light emitted from the light source.

In the first aspect of the invention, the variable spectroscopic device includes optical members opposing to each other at a distance, and the spectrum transmittance may be varied by changing the distance between the optical members.

In the first and second aspects of the invention, the reflected light includes a light-absorbing band of hemoglobin and is light having a wavelength in a band narrower than a band from green to blue included in a spectrum sensitivity band of the image pickup device including the respective bands of red, green and blue.

In the first and second aspects of the invention, the light source may be arranged outside the body cavity.

In the first and second aspects of the invention, the exposure value may be controlled on the basis of the intensity of at least one image acquired by the image pickup device.

In the first and second aspects of the invention, the arithmetic processing is processing to standardize the intensity of other images by the intensity of at least one image acquired by the image pickup device.

### BRIEF DESCRIPTION OF THE SEVERAL VIEWS OF THE DRAWINGS

FIG. 1 is a block diagram showing an entire configuration of an endoscope system according to a first embodiment of the invention;

FIG. 2 is a schematic configuration drawing showing a configuration of the interior of an image pickup unit of the endoscope system shown in FIG. 1;

FIG. 3 is a drawing showing transmittance characteristics and wavelength characteristics of irradiation light and fluorescent light of respective optical components which constitute the endoscope system shown in FIG. 1;

FIG. 4 is a timing chart that explains an action of the endoscope system shown in FIG. 1;

FIG. 5 is a block diagram showing an entire configuration of the endoscope system according to a second embodiment of the invention;

FIG. 6 is a drawing showing transmittance characteristics and wavelength characteristics of irradiation light and fluorescent light of respective optical components which constitute the endoscope system shown in FIG. 5;

FIG. 7 is a timing chart for explaining an action of the endoscope system shown in FIG. 5;

FIG. 8 is a schematic configuration drawing showing a configuration of the interior of the image pickup unit of the endoscope system according to a third embodiment of the invention;

FIG. 9 is a pattern diagram showing a mosaic filter arranged in the image pickup unit shown in FIG. 8; and

FIG. 10 is a drawing showing transmittance characteristics of the mosaic filter in FIG. 9.

### DETAILED DESCRIPTION OF THE INVENTION

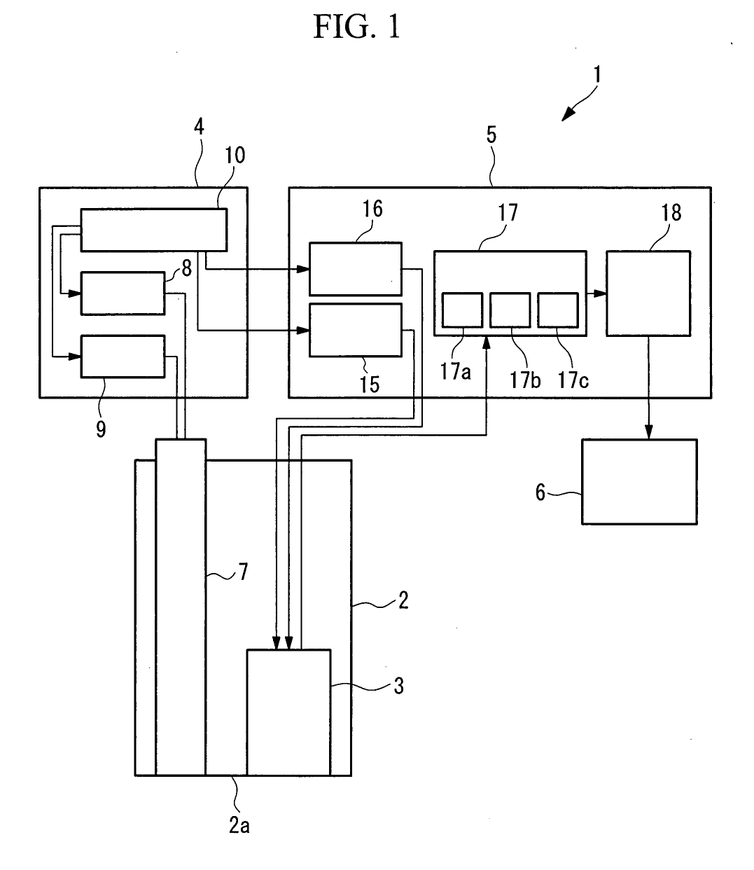

Referring now to FIG. 1 to FIG. 4, an endoscope system 1 according to a first embodiment of the invention will be described.

As shown in FIG. 1, the endoscope system 1 according to the first embodiment includes an insertion section 2 to be inserted into a body cavity of a living body, an image pickup unit (image pickup device) to be arranged in the insertion section 2, a light source unit (light source) 4 that emits a plurality of types of light, a control unit (controller) 5 that controls the image pickup unit 3 and the light source unit 4, and a display unit (display) 6 that displays images acquired by the image pickup unit 3.

The insertion section 2 has an extremely thin external dimension which allows insertion into the body cavity of the living body, and includes the image pickup unit 3 and a light guide (light guide optical system) 7 that propagates light from the light source unit 4 to a distal end 2a in the interior thereof.

The light source unit 4 includes an illumination light source 8 that emits illumination light (irradiation light) for illuminating an object to be observed A in the body cavity and acquiring reflected light which is reflected from the object to be observed and returned (illumination light), an excitation light source 9 that emits excitation light to be radiated onto the object to be observed in the body cavity and exciting fluorescent substances existing in the object to be observed for causing the fluorescent light to be generated, and a light source control circuit 10 for controlling the light sources 8 and 9.

The illumination light source 8 is, for example, a combination of a xenon lamp and a band-pass filter, not shown, and the 50% transmission area of the band-pass filter ranges from 430 nm to 460 nm. That is, the illumination light source 8 is adapted to generate illumination light in a wavelength band from 430 nm to 460 nm.

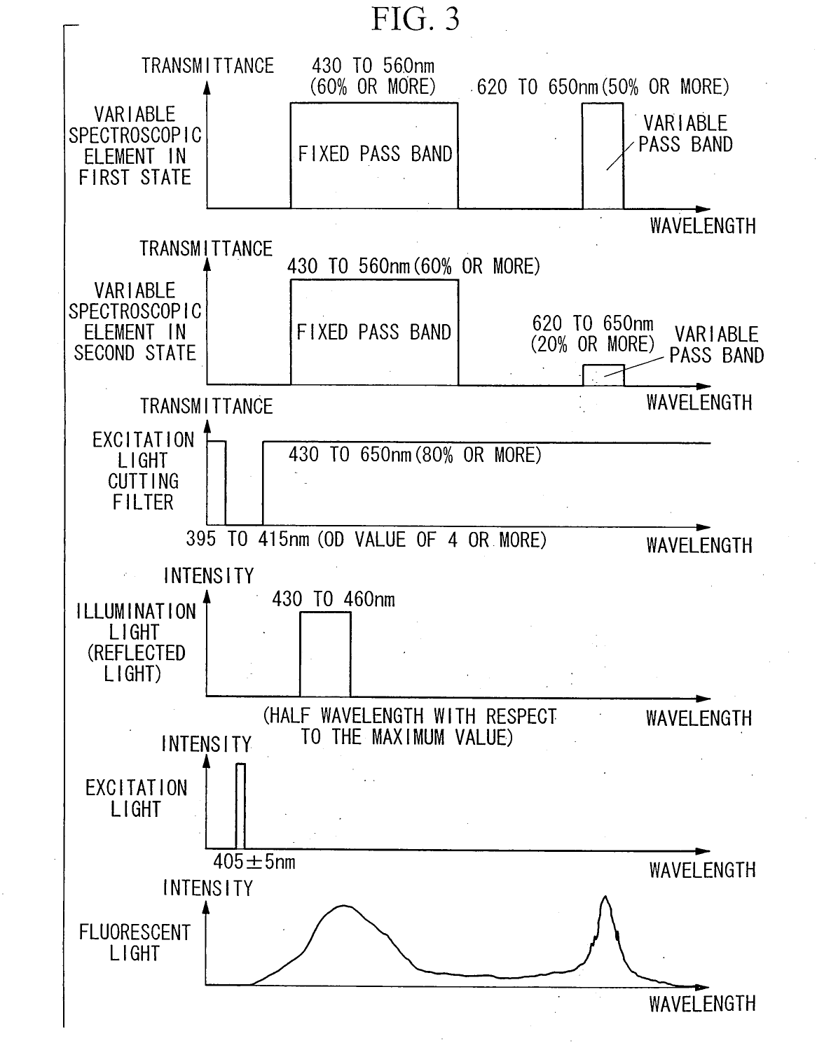

The excitation light source 9 is, for example, a semiconductor laser that emits excitation light having a peak wavelength of 405±5 nm. The excitation light having this wavelength excites a plurality of autofluorescent components shown in FIG. 3.

The light source control circuit 10 is adapted to turn on and off the illumination light source 8 and the excitation light source 9 at a predetermined timing according to a timing chart, described later.

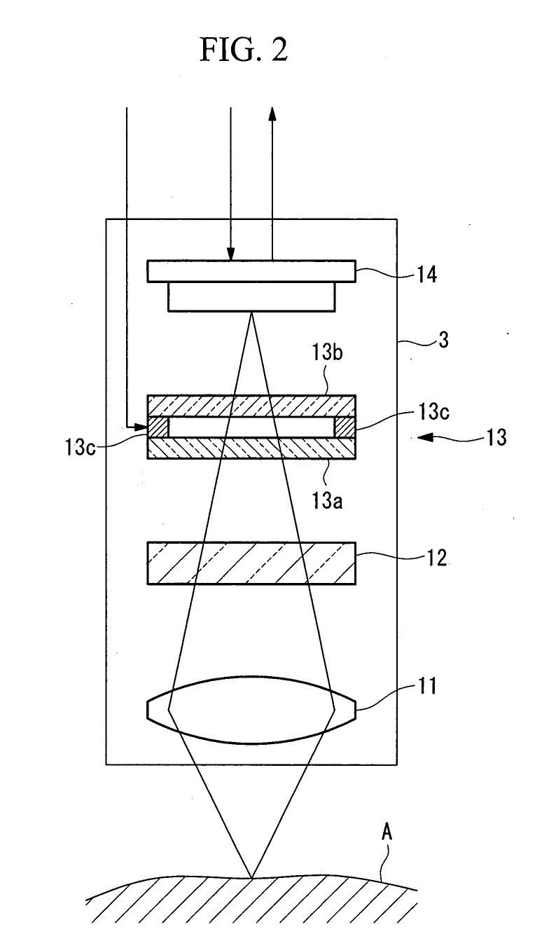

As shown in FIG. 2, the image pickup unit 3 includes an image pickup optical system 11 that collects light incoming from the object to be observed A, an excitation light cutting filter 12 that blocks the excitation light incoming from the object to be observed A, the variable spectroscopic element (variable spectroscopic section) 13 whose spectral characteristics are varied by the operation of the control unit 5, and an image pickup element 14 that picks up an image of the light collected by the image pickup optical system 11 and converts the same into electrical signal.

The variable spectroscopic element 13 is an etalon-type optical filter including two plate-shaped optical members 13a and 13b arranged in parallel at a distance and having reflection films on opposing surfaces thereof and an actuator 13c for varying the distance between the optical members 13a and 13b. The actuator 13c is, for example, a piezoelectric element. The variable spectroscopic element 13 is adapted to be able to vary the wavelength band of light which transmits therethrough by varying the distance between the optical elements 13a and 13b by the operation of the actuator 13c.

More specifically, as shown in FIG. 3, the variable spectroscopic element 13 has a transmittance wavelength characteristic having two pass bands, that is, one fixed pass band and one variable pass band. The fixed pass band is adapted to always transmit incident light irrespective of the state of the variable spectroscopic element 13. The variable pass band is adapted in such a manner that the transmittance characteristics vary with the state of the variable spectroscopic element 13.

In the first embodiment, the variable spectroscopic element 13 includes the variable pass band in a wavelength band which includes wavelengths belonging to a long wavelength side (for example, from 620 nm to 650 nm), from between two types of fluorescent light (autofluorescent light) outputted by the substances existing originally in the living body being excited by the excitation light. The variable spectroscopic element 13 is adapted to be varied into two states according to control signals supplied from the control unit 5.

The first state of the variable spectroscopic element 13 is a state in which the transmittance in the variable pass band is increased to 50% or more to transmit the autofluorescent light on the long wavelength side. The second state of the variable spectroscopic element 13 is a state in which the transmittance in the variable pass band is decreased to 20% or lower to block the autofluorescent light on the long wavelength side.

In the second state, the variable spectroscopic element 13 may block the autofluorescent light by varying the wavelength band of the variable pass band from the first state.

The fixed pass band of the variable spectroscopic element 13 is arranged, for example, in a range from 430 nm to 560 nm, and is fixed to a transmittance of 60% or more.

The fixed pass band of the variable spectroscopic element 13 is positioned in a wavelength band including wavelengths of the autofluorescent light on the short wavelength side and wavelengths of reflected light of the illumination light. Accordingly, the variable spectroscopic element 13 is adapted to allow the autofluorescent light on the short wavelength side and the reflected light to transmit toward the image pickup element 14 either in the first and second states.

According to the transmittance characteristics of the excitation light cutting filter 12, the OD value is at least 4 (=transmittance 1×10⁻⁴ or smaller) in a wavelength band from 395 nm to 415 nm and the transmittance is at least 80% in a wavelength band from 430 nm to 650 nm.

As shown in FIG. 1, the control unit 5 includes an image pickup element control circuit 15 that drives and controls the image pickup element 14, a variable spectroscopic element control circuit 16 that drives and controls the variable spectroscopic element 13, a frame memory 17 that stores image data acquired by the image pickup element 14, and an image processing circuit 18 that processes the image data stored in the frame memory 17 and outputs the same to the display unit 6.

The image pickup element control circuit 15 and the variable spectroscopic element control circuit 16 are connected to the light source control circuit 10. Accordingly, the image pickup element control circuit 15 and the variable spectroscopic element control circuit 16 are adapted to drive and control the variable spectroscopic element 13 and the image pickup element 14 synchronously with switching between the illumination light source 8 and the excitation light source 9 by the light source control circuit 10.

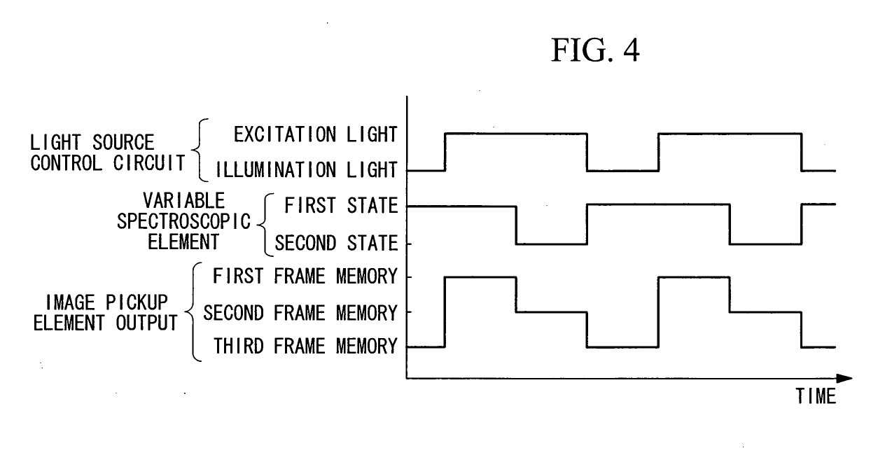

Specifically, as shown in a timing chart in FIG. 4, when the excitation light is emitted from the excitation light source 9 by the operation of the light source control circuit 10, the variable spectroscopic element control circuit 16 is adapted to maintain the variable spectroscopic element 13 in the first state and the image pickup element control circuit 15 is adapted to output image data outputted from the image pickup element 14 to a first frame memory 17a. Also, after a predetermined time has elapsed from the emission of the excitation light from the excitation light source 9, the variable spectroscopic element control circuit 16 is adapted to bring the variable spectroscopic element 13 into the second state and the image pickup element control circuit 15 is adapted to output image data outputted from the image pickup element 14 to a second frame memory 17b. Moreover, when the illumination light is emitted from the illumination light source 8, the variable spectroscopic element control circuit 16 is adapted to switch the variable spectroscopic element 13 to the first state again, and the image pickup element control circuit 15 is adapted to output image data outputted from the image pickup element 14 to a third frame memory 17c.

Therefore, the image data stored in the first frame memory 17a is image data acquired by bringing the variable spectroscopic element 13 into the first state and radiating the excitation light, and hence is first fluorescent image data in which two fluorescent components are mixed. The image data stored in the second frame memory 17b is image data acquired by bringing the variable spectroscopic element 13 into the second state and radiating the excitation light, and hence is second fluorescent image data including only the fluorescent components on the short wavelength side. Moreover, the image data stored in the third frame memory 17c is image data acquired by brining the variable spectroscopic element 13 into the first state and radiating the illumination light, and hence is reflected light image data.

The image processing circuit 18 is adapted to, for example, receive the second fluorescent image data from the second frame memory 17b and output the same to a first channel of the display unit 6, receive the first and second fluorescent image data from the first and second frame memories 17a and 17b and output image data acquired by subtracting the second fluorescent image data from the first fluorescent image data to a second channel of the display unit 6, and receive reflected light image data from the third frame memory 17c and output the same to a third channel of the display unit 6.

Operation of the endoscope system 1 according to the first embodiment configured as described thus far will be described below.

In order to pick up an image of the object to be observed A in the body cavity of the living body using the endoscope system 1 according to the first embodiment, the insertion section 2 is inserted into the body cavity to oppose the distal end 2a thereof to the object to be observed A in the body cavity. In this state, the light source unit 4 and the control unit 5 are operated to cause the light source control circuit 10 to be operated to switch the light source between the illumination light source 8 and the excitation light source 9 and activate the same, so that the illumination light and the excitation light are generated, respectively.

The excitation light and the illumination light generated in the light source unit 4 are propagated to the distal end 2a of the insertion section 2 respectively via the light guide 7, and is radiated from the distal end 2a of the insertion section 2 onto the object to be observed A.

When the object to be observed A is irradiated with the excitation light, the fluorescent substances originally existing in the object to be observed A are excided and two types of autofluorescent light are emitted. The autofluorescent light emitted from the object to be observed A is collected by the image pickup optical system 11 of the image pickup unit 3, is transmitted through the excitation light cutting filter 12, and enters the variable spectroscopic element 13.

Since the variable spectroscopic element 13 is maintained in the first state synchronously with the operation of the excitation light source 9 by operation of the variable spectroscopic element control circuit 16, the transmittances for the two autofluorescent components are increased, and both of the incoming two autofluorescent components are transmitted therethrough. Then, the two autofluorescent components transmitted through the variable spectroscopic element 13 enter the image pickup element 14, and first fluorescent image data is acquired. The acquired first fluorescent image data is stored in the first frame memory 17a.

In this case, a part of the excitation light being radiated onto the object to be observed A is reflected from the object to be observed A, and enters the image pickup unit 3 together with the autofluorescent components. However, since the image pickup unit 3 is provided with the excitation light cutting filter 12, the excitation light is blocked and hence is prevented from entering the image pickup element 14.

Subsequently, the variable spectroscopic element 13 is switched to the second state after a predetermined time has elapsed from the operation of the excitation light source 9 by operation of the variable spectroscopic element control circuit 16. Accordingly, the transmittance for the autofluorescent light components on the long wavelength side is lowered, and only the autofluorescent components on the short wavelength side from between the entering two autofluorescent components are transmitted. Then, the autofluorescent components on the short wavelength side transmitted through the variable spectroscopic element 13 enter the image pickup element 14 and the second fluorescent image data is acquired. The acquired second fluorescent image data is stored in the second frame memory 17b.

On the other hand, when the object to be observed A is irradiated with the illumination light, the illumination light is reflected from the surface of the object to be observed A, is collected by the image pickup optical system 11, is transmitted through the excitation light cutting filter 12, and enters the variable spectroscopic element 13. Since the wavelength band of the reflected light of the illumination light is positioned in the fixed pass band of the variable spectroscopic element 13, the entire reflected light entering the variable spectroscopic element 13 transmits through the variable spectroscopic element 13.

Then, the reflected light transmitted through the variable spectroscopic element 13 enters the image pickup element 14, and reflected light image data is acquired. The acquired reflected light image data is stored in the third frame memory 17c.

Subsequently, the image processing circuit 18 reads the first and second fluorescent image data stored in the first and second frame memories 17a and 17b and subtracts the second fluorescent image data from the first fluorescent image data. Accordingly, the image processing circuit 18 generates the fluorescent image data of the autofluorescent components on the long wavelength side, outputs the same to the second channel of the display unit 6, outputs the second fluorescent image data read from the second frame memory 17b as is to the first channel of the display unit 6, and outputs the reflected light image data read from the third frame memory 17c as is to the second channel of the display unit 6 to be displayed on the display unit 6.

In this manner, according to the endoscope system 1 in the first embodiment, an image formed by combining the two types of images, that is, the autofluorescent image and the reflected light image is provided to a user.

In this case, according to the endoscope system 1 in the first embodiment, the state of the variable spectroscopic element 13 is switched synchronously with the switching of the plurality of light sources 8 and 9 in the light source unit 4 and the state of the variable spectroscopic element 13 is switched while radiation of the excitation light from the excitation light source 9 so that the two fluorescent image data and the one reflected light image data are acquired at the same position in a time-sharing manner.

Consequently, the two fluorescent image data and the one reflected light image data are acquired before the relative position or the posture of the image pickup element 14 with respect to the object to be observed A is changed, so that accurate extraction of the fluorescent image on the long wavelength side by arithmetic processing between the fluorescent images is achieved. In the case of displaying the reflected light image and the fluorescent image in a superimposed manner, a clear image display without any misalignment is achieved without performing complicated correcting process. Consequently, complexity of the endoscope system 1 is prevented.

Since the state of the variable spectroscopic element 13 is switched synchronously with switching of the plurality of light sources 8 and 9 in the light source unit 4, images of a plurality of types of fluorescent light or reflected light in different wavelength bands are picked up by the identical image pickup element 14. Therefore, it is not necessary to provide a plurality of image pickup optical systems corresponding to the fluorescent light or reflected light. Consequently, the diameter of the insertion section 2 may be reduced.

According to the endoscope system 1 in the first embodiment, since the variable spectroscopic element 13 which varies the transmittance characteristics only by changing the distance between the plate-shaped optical members 13a and 13b is employed, the extremely compact variable spectroscopic element 13 and image pickup element 14 is arranged at the distal end 2a of the insertion section 2. Therefore, it is not necessary to take the fluorescent light or the reflected light from the object to be observed A out of the body using a fiber bundle.

Since outside light which transmits anatomy exists even in the body cavity of the living body, it is important to reduce noise when observing weak light such as the case of the fluorescent observation. However, in the first embodiment, since light other than light having a wavelength of the object to be observed is always blocked even when the wavelength band to be observed is varied by providing the variable spectroscopic element 13 in the image pickup unit 3, preferred image in which the noise is reduced is acquired.

In addition, in the first embodiment, the illumination light source 8 generates the illumination light in a wavelength band from 430 nm to 460 nm. The wavelength band includes a light-absorbing band of hemoglobin, and hence data such as the structure of blood vessels located relatively near the surface of the living body is acquired by picking up the image of the reflected light therefrom.

In the endoscope system 1 according to the first embodiment, the image pickup optical system 11, the excitation light cutting filter 12, and the variable spectroscopic element 13 are arranged in the image pickup unit 3 from the distal end 2a side of the insertion section 2 in this order. However, the order of arrangement of these components is not limited thereto, and the arbitrary order of arrangement is employed.

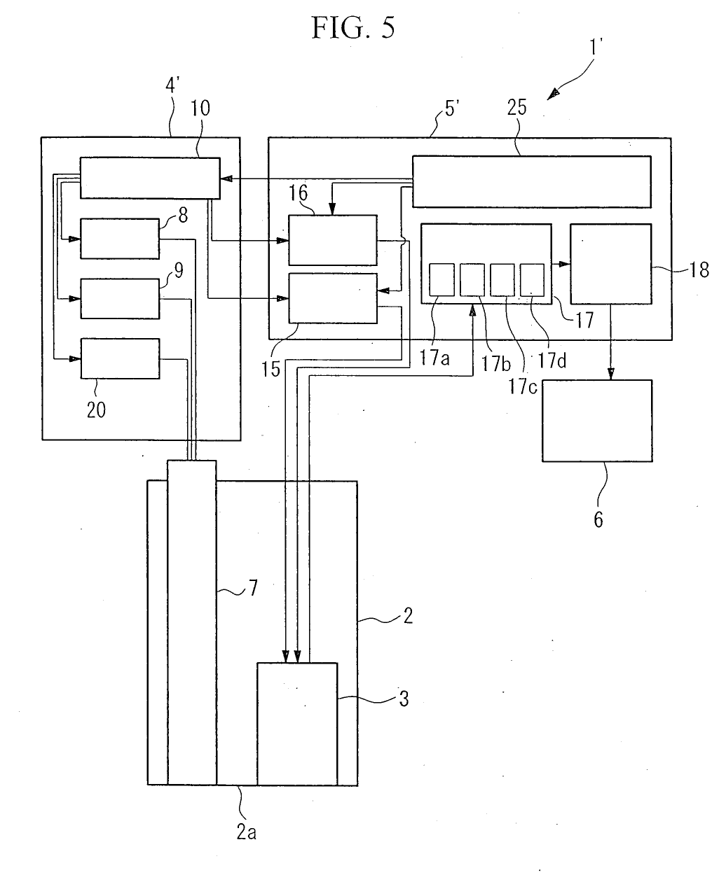

Subsequently, referring to FIG. 5 to FIG. 7, an endoscope system 1′ according to a second embodiment of the invention will be described below.

In the description of the second embodiment, parts having common structure as the above described endoscope system 1 according to the first embodiment are represented by the same reference numerals and description thereof is omitted.

The endoscope system 1′ according to the second embodiment picks up an image of one type of agent fluorescence in addition to the endoscope system 1 according to the first embodiment which picks up images of the two types of autofluorescent light and the reflected light.

A light source unit 4′ includes another excitation light source 20 in addition to the excitation light source 9 as shown in FIG. 5. The frame memory 17 is additionally provided with a fourth frame memory 17d. A control unit 5′ is additionally provided with an observation mode selecting circuit 25.

The excitation light source 20 is a semiconductor laser that emits excitation light having a peak wavelength of, for example, 660±5 nm. The excitation light having this wavelength is able to excite the fluorescent agent which generates fluorescent light having a peak near 700 nm.

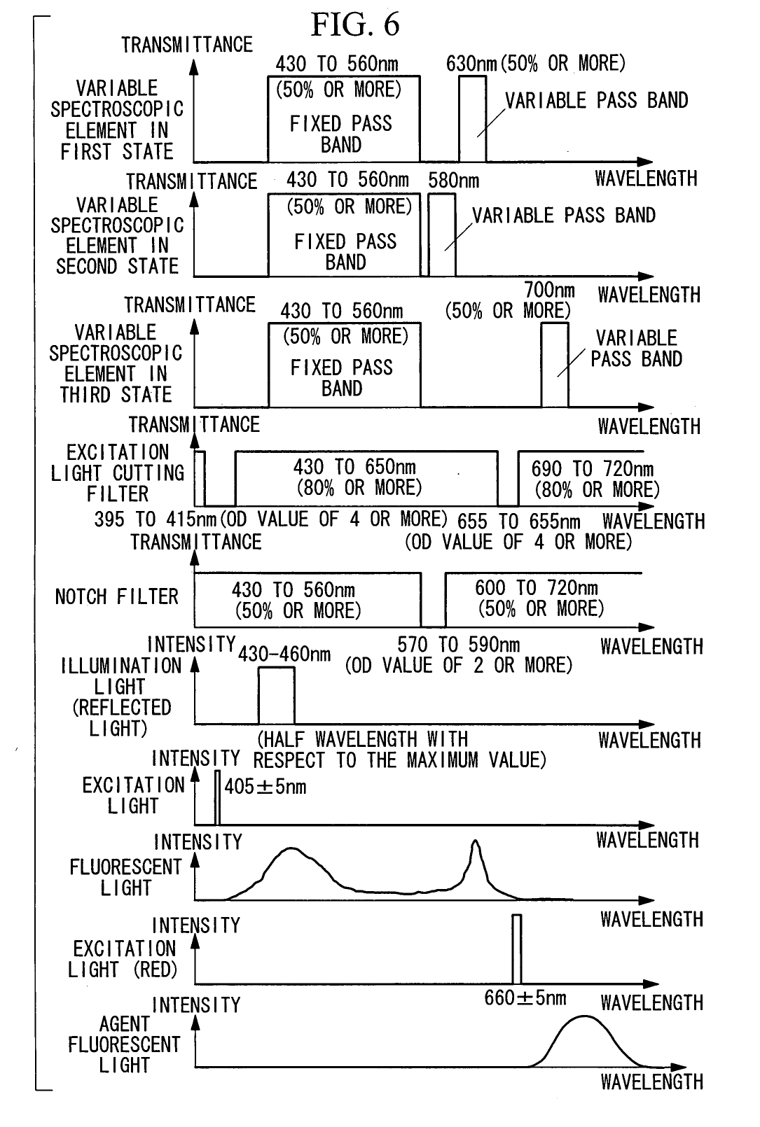

The variable spectroscopic element 13 includes a transmittance wavelength characteristic having two pass bands, that is, one fixed pass band and one variable pass band, as shown in FIG. 6. The fixed pass band is adapted to always transmit incident light irrespective of the state of the variable spectroscopic element 13. The variable pass band is adapted in such a manner that the pass band varies with the state of the variable spectroscopic element 13.

In the second embodiment, the variable spectroscopic element 13 is adapted to move the variable pass band to three states according to control signals supplied from the control unit 5′.

That is, the first state of the variable spectroscopic element 13 is a state in which the variable pass band coincides with the wavelength band including the wavelengths belonging to the long wavelength side (for example, from 620 nm to 650 nm), from between two types of fluorescent light (autofluorescent light) emitted by the substances originally existing in the living body being excited by the excitation light. Accordingly, the autofluorescent light on the long wavelength side is transmitted.

The third state of the variable spectroscopic element 13 is a state in which the variable pass band coincides with the wavelength band of the agent fluorescence (for example, from 685 nm to 715 nm) . Accordingly, the agent fluorescent light is transmitted.

The second state of the variable spectroscopic element 13 is a state in which the variable pass band is included in a wavelength band different from the first state and the third state (for example, 565 nm to 595 nm) . Accordingly, the autofluorescent light and the agent fluorescent light on the long wavelength side is blocked.

The fixed pass band of the variable spectroscopic element 13 is arranged in a range, for example, from 430 nm to 560 nm, and is fixed to a transmittance of 60% or more.

The fixed pass band of the variable spectroscopic element 13 is included in a wavelength band including the wavelength of the autofluorescent light on the short wavelength side and the wavelength of the reflected light of the illumination light, so that the autofluorescent light and the reflected light on the short wavelength side are transmitted toward the image pickup element 14 in either of the first and second states.

According to the transmittance characteristics of the excitation light cutting filter 12, the OD value is at least 4 (=transmittance 1×10⁻⁴ or smaller) in a wavelength band from 395 nm to 415 nm and the transmittance is at least 80% in a wavelength band from 430 nm to 650 nm.

In addition to the excitation light cutting filter 12, it is preferable to arrange a notch filter having the transmittance characteristics which achieve the OD value of at least 2 (=transmittance 1×10⁻² or smaller) in the wavelength band from 570 nm to 590 nm, and a transmittance of 50% or more in a wavelength bands from 430 nm to 560 nm and from 600 nm to 720 nm. In this configuration, the transmittance characteristics on the long wavelength side of the fixed pass band which vary in association with the switching of the variable pass band in the variable spectroscopic element 13 may be collected.

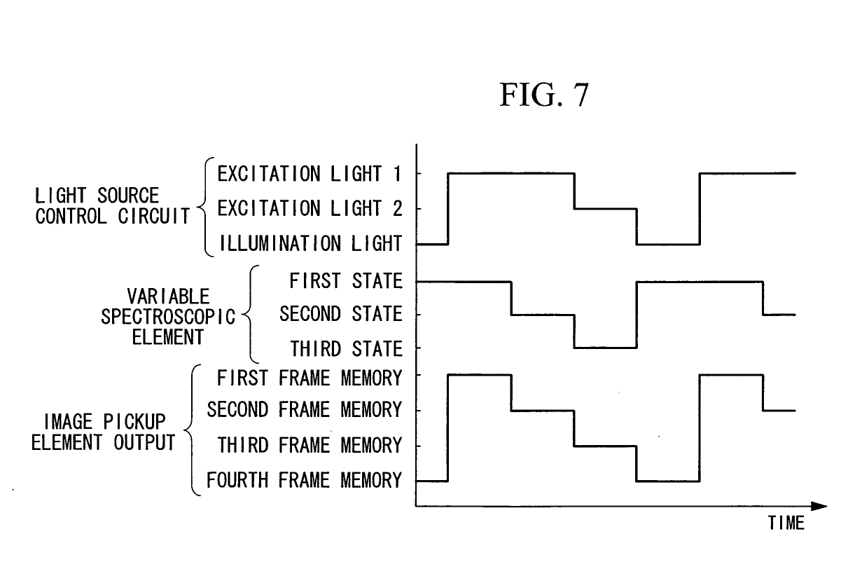

As shown in a timing chart in FIG. 7, when the first excitation light is emitted from the excitation light source 9 by the operation of the light source control circuit 10, the variable spectroscopic element control circuit 16 maintains the variable spectroscopic element 13 in the first state and the image pickup element control circuit 15 causes the image data outputted from the image pickup element 14 to be outputted to the first frame memory 17a.

After having elapsed a predetermined time from emission of the first excitation light from the excitation light source 9, the variable spectroscopic element control circuit 16 brings the variable spectroscopic element 13 into the second state, and image pickup element control circuit 15 causes the image data outputted from the image pickup element 14 to be outputted to the second frame memory 17b.

When the second excitation light is emitted from the excitation light source 20, the variable spectroscopic element control circuit 16 switches the variable spectroscopic element 13 into the third state, and the image pickup element control circuit 15 causes the image data outputted from the image pickup element 14 to be outputted to the third frame memory 17c.

When the illumination light is emitted from the illumination light source 8, the variable spectroscopic element control circuit 16 switches the variable spectroscopic element 13 into the first state again, and the image pickup element control circuit 15 causes the image data outputted from the image pickup element 14 to be outputted to the fourth frame memory 17d.

When the illumination light is emitted from the illumination light source 8, the variable spectroscopic element control circuit 16 is adapted to switch the variable spectroscopic element 13 into the first state again, and the image pickup element control circuit 15 is adapted to cause the image data outputted from the image pickup element 14 to be outputted to the fourth frame memory 17d.

Therefore, since the image data stored in the first frame memory 17a is image data acquired by bringing the variable spectroscopic element 13 into the first state and radiating the first excitation light, it is mixed autofluorescent image data in which the two autofluorescent components are mixed. Since the image data stored in the second frame memory 17b is image data acquired by bringing the variable spectroscopic element 13 into the second state and radiating the first excitation light, it is short wavelength autofluorescent image data which only includes the autofluorescent components on the short wavelength side. Moreover, since the image data stored in the third frame memory 17c is image data acquired by bringing the variable spectroscopic element 13 into the third state and radiating the second excitation light, it is agent fluorescent image data including only the agent fluorescent light. Since the image data stored in the fourth frame memory 17d is image data acquired by bringing the variable spectroscopic element 13 into the first state and radiating the illumination light, it is reflected light image data.

An observation mode selection circuit 25 is adapted to select the image data to be displayed by input operation of an observer. As described above, the endoscope system 1′ according to the second embodiment acquires four images including the two autofluorescent components, the one agent fluorescent component and the reflected light component. The output channel of the normal display unit 6 includes the first to third channels of red, green, and blue, so that three images are selected from among four images and are displayed in a superimposed manner via the observation mode selection circuit 25.

For example, when superimposed display of the short wavelength autofluorescent image data, the agent fluorescent image data, and the reflected light image data is desired, the image data stored in the second to fourth frame memories 17b to 17b may be outputted as is to the first to third channels of the display unit 6.

When display of the long wavelength autofluorescent image data including only the autofluorescent components on the long wavelength side is desired, the observation mode selection circuit 25 may activate the image processing circuit 18, calculate the long wavelength autofluorescent image data by subtracting the short wavelength autofluorescent image data received from the second frame memory 17b from the mixed autofluorescent image data received from the first frame memory 17a, and output the calculated result to any one of the channels of the display unit 6.

Operation of the endoscope system 1′ according to the second embodiment configured in this manner will be described below.

Here, a case in which the autofluorescent image data, the agent fluorescent image data, and the reflected light image data on the long wavelength side of the object to be observed A in the body cavity of the living body are displayed in a superimposed manner on the display unit 6 will be described using the endoscope system 1′ according to the second embodiment.

In order to observe the object to be observed A using the endoscope system 1′ according to the second embodiment, firstly, fluorescent agent is injected into the body, the insertion section 2 is inserted into the body cavity, and the distal end 2a thereof is opposed to the object to be observed A in the body cavity. In this state, the light source unit 4′ and the control unit 5′ are activated, the illumination light source 8 and the excitation light sources 9 and 20 are switched and activated to generate illumination light and the first and second excitation light respectively.

The first and second excitation light and the illumination light generated by the light source unit 4 are propagated to the distal end 2a of the insertion section 2 via the light guide 7 respectively, and radiated onto the object to be observed A from the distal end 2a of the insertion section 2.

When the object to be observed A is irradiated with the first excitation light, the fluorescent substances originally existing on the object to be observed A is excited and hence two types of autofluorescent light are emitted. The autofluorescent light emitted from the object to be observed A is collected by the image pickup optical system 11 of the image pickup unit 3, is transmitted through the excitation light cutting filter 12, and enters the variable spectroscopic element 13.

The variable spectroscopic element 13 is maintained in the first state synchronously with the operation of the excitation light source 9 by the operation of the variable spectroscopic element control circuit 16. Accordingly, the transmittances for the two autofluorescent components are increased, and both of the entering two autofluorescent light components are transmitted. Then, the two autofluorescent components transmitted though the variable spectroscopic element 13 enters the image pickup element 14, and the mixed autofluorescent image data is acquired. The acquired mixed autofluorescent image data is stored in the first frame memory 17a.

In this case, a part of the excitation light radiated onto the object to be observed A is reflected from the object to be observed A, and enters the image pickup unit 3 together with the autofluorescent component. However, since the excitation light cutting filter 12 is provided in the image pickup unit 3, the excitation light is blocked and is prevented from entering the image pickup element 14.

Subsequently, the variable spectroscopic element 13 is switched into the second state after having elapsed a predetermined time from the operation of the excitation light source 9 by the operation of the variable spectroscopic element control circuit 16. Accordingly, only the autofluorescent component on the short wavelength side from between the two autofluorescent components entering the variable spectroscopic element 13 is transmitted. Then, the autofluorescent component on the short wavelength side transmitted through the variable spectroscopic element 13 enters the image pickup element 14, and the short wavelength autofluorescent image data is acquired. The acquired short wavelength autofluorescent image data is stored in the second frame memory 17b.

When the object to be observed A is irradiated with the second excitation light, the fluorescent agent permeated into the object to be observed A is excited and hence the agent fluorescent light is emitted. The agent fluorescent light is collected by the image pickup optical system 11 of the image pickup unit 3, is transmitted through the excitation light cutting filter 12, and enters the variable spectroscopic element 13.

The variable spectroscopic element 13 is switched to the third state synchronously with the operation of the excitation light source 20 by the operation of the variable spectroscopic element control circuit 16. Accordingly, the transmittances for the agent fluorescent component of the variable spectroscopic element 13 is increased, so that the entering agent fluorescent light is transmitted. Then, the agent fluorescent light transmitted through the variable spectroscopic element 13 enters the image pickup element 14, and the agent fluorescent image data is acquired. The acquired agent fluorescent image data is stored in the third frame memory 17c.

On the other hand, when the object to be observed A is irradiated with the illumination light, the illumination light is reflected from the surface of the object to be observed A, is collected by the image pickup optical system 11, is transmitted through the excitation light cutting filter 12, and enters the variable spectroscopic element 13. Since the wavelength band of the reflected light of the illumination light is included in the fixed pass band of the variable spectroscopic element 13, the entire reflected light entering the variable spectroscopic element 13 is transmitted through the variable spectroscopic element 13.

The reflected light transmitted through the variable spectroscopic element 13 enters the image pickup element 14, and the reflected light image data is acquired. The acquired reflected light image data is stored in the fourth frame memory 17d.

Subsequently, the image processing circuit 18 generates the long wavelength autofluorescent image data by reading out the mixed autofluorescent image data and the short wavelength autofluorescent image data stored in the first and second frame memories 17a and 17b and subtracting the short wavelength autofluorescent image data from the mixed autofluorescent image data. Then, the long wavelength autofluorescent image data, the agent fluorescent image data, and the reflected light image data calculated in this manner are outputted to the first to third channels of the display unit 6 respectively, so that superimposed display is achieved by the display unit 6.

In this manner, according to the endoscope system 1′ in the second embodiment, an image acquired by combining the long wavelength autofluorescent image, the agent fluorescent image, and the reflected light image may be provided to the user.

In this case, according to the endoscope system 1′ in the second embodiment, the state of the variable spectroscopic element 13 is switched synchronously with the switching of the plurality of light sources 8, 9, and 20 in the light source unit 4′, and the state of the variable spectroscopic element 13 is switched during radiation of the first excitation light from the excitation light source 9, so that the two autofluorescent image data, the one agent fluorescent image data, and the one reflected light image data are acquired at the same position in a time-sharing manner.

Consequently, the three fluorescent image data and the one reflected light image data are acquired before the relative position or the posture of the image pickup element 14 with respect to the object to be observed A is changed, and hence the accurate extraction of the autofluorescent image on the long wavelength side by the arithmetic processing among the fluorescent images is achieved. The three fluorescent images and the one reflected light image are displayed in a superimposed manner, so that a clear image display without misalignment may be achieved without performing a complicated correcting process. Consequently, the complexity of the endoscope system 1′ may be prevented.

In the second embodiment, the case of acquiring all the image data has been described. However, when the long wavelength autofluorescent image data is not displayed, the step of acquiring the mixed autofluorescent image data is not necessary. In the second embodiment, the case of operating all the light sources has been described. However, when there is image data which is not selected, the light source control circuit 10 may be adapted to stop the operation of some light sources under the instruction of the observation mode selection circuit 25. In this case, the variable spectroscopic element control circuit 16 and the image pickup element control circuit 15 are also controlled according to a timing chart different from FIG. 7.

It is also applicable to generate a standardized image data acquired by standardizing three image data from the acquired four image data by remaining one image data through the selection of the method of observation by the observation mode selection circuit 25 and display these in a superimposed manner. For example, a configuration to output standardized agent fluorescent image data acquired by dividing the agent fluorescent image data by the long wavelength autofluorescent image data from pixel to pixel to the first channel, standardized autofluorescent image data acquired by dividing the short wavelength autofluorescent image data by the long wavelength autofluorescent image data from pixel to pixel to the second channel, and standardized reflected light image data acquired by dividing the reflected light image data by the long wavelength autofluorescent image data from pixel to pixel may be outputted respectively to the third channel.

In this configuration, there is an advantage such that variation of the exposure value in the image pickup element 14 on the basis of the variation of the light amount from the light source or the variation of the distance from the object to be observed A is adjusted. There is also an advantage such that a portion to be inspected such as a diseased tissue is displayed further distinctly by emphasizing the pixels whose light amount is small through the standardization.

Alternatively, it is also possible to adjust the exposure value in the image pickup element 14 by calculating an average value or a maximum value within an entire or part of the range of any image data, returning a feedback of the same to the light source control circuit 10, and adjusting the light amount of each light source.

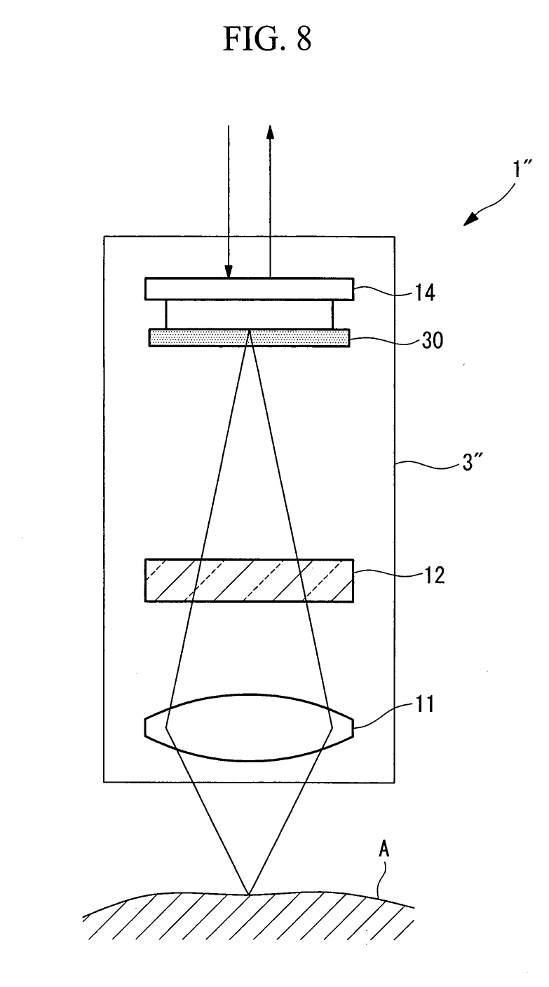

Referring now to FIG. 8 to FIG. 10, an endoscope system 1″ according to a third embodiment of the invention will be described below.

The endoscope system 1″ according to the third embodiment is different from the endoscope systems 1 and 1′ according to the first and second embodiments which employ the variable spectroscopic element 13 in that a mosaic filter 30 (spectral means) is used.

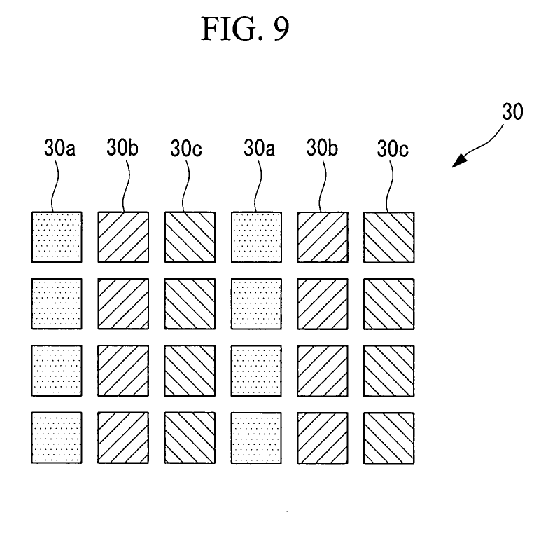

The mosaic filter 30 is arranged next to the image pickup element 14 on the upstream side as shown in FIG. 8. The mosaic filter 30 includes a plurality of types of filter strips (optical filters) 30a to 30c arranged corresponding to the respective pixels of the image pickup element 14 as shown in FIG. 9, and in the third embodiment, the three types of filter strip 30a to 30c are provided.

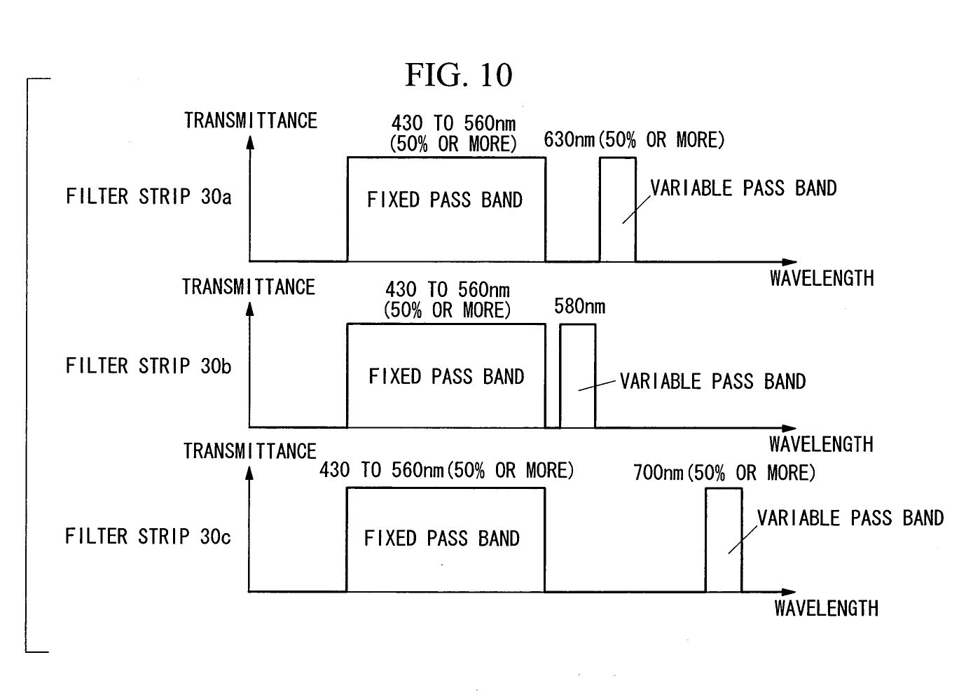

The respective filter strips 30a to 30c of the mosaic filter 30 have transmittance characteristics as shown in FIG. 10. That is, all the filter strips 30a to 30c have a common pass band on the short wavelength side, and have different pass bands different from each other on the long wavelength side thereof. Accordingly, the three types of filter strip 30a to 30c have the same transmittance characteristics as the variable spectroscopic element 13 of the endoscope system 1′ according to the above-described second embodiment as a whole.

Therefore, the same effect as the second embodiment is achieved by storing only image information acquired by the pixels corresponding to the filter strips 30a to 30c of the same type in the same frame memories 17a to 17c respectively using the same light sources 8, 9, and 20 as in the endoscope system 1′ and the timing chart according to the second embodiment.

The fluorescent endoscope systems 1, 1′, and 1″ according to the invention are not limited to a scope type having the image pickup element 14 at the distal end of the insertion section 2 which is inserted into the body cavity of the living body, but a capsule type which includes a light source, an image pickup device, and a variable spectroscopic unit provided in one casing, and may be inserted into the body cavity of the living body entirely as the housing can also be applied.

What is claimed is:

1. An endoscope system that acquires images of an object to be observed in a body cavity of a living body by being introduced at least partly into the body cavity comprising:
a light source that emits a plurality of types of irradiation light having different spectral characteristics and being radiated onto the object to be observed;
an optical system that propagates the irradiation light from the light source toward the object to be observed;
an image pickup device which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light;
a variable spectroscopic device which is arranged in an optical path between the image pickup device and the distal end of the portion to be inserted into the body cavity and is capable of changing the wavelength band of light entering the image pickup device from the object to be observed by varying the spectral characteristics thereof; and
a controller that controls the light source, the variable spectroscopic device, and the image pickup device so as to acquire an image of the fluorescent light in a plurality of the wavelength bands and of the light different in wavelength band from the fluorescent light at the same position in a time-sharing manner.

2. An endoscope system that acquires images of an object to be observed in a body cavity of a living body by being introduced at least partly into the body cavity comprising:
a light source that emits a plurality of types of irradiation light having different spectral characteristics and being radiated onto the object to be observed;
an optical system that propagates the irradiation light from the light source toward the object to be observed;
an image pickup device which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light;
a spectrum forming device which is arranged in an optical path between the image pickup device and the distal end of the portion to be inserted into the body cavity and spatially forming spectrum of light incoming from the object to be observed into the image pickup device; and
a controller that controls the light source and the image pickup device so as to acquire an image of the fluorescent light in a plurality of the wavelength bands and of the light different in wavelength band from the fluorescent light substantially at the same time.

3. The endoscope system according to claim 2, wherein the spectrum forming device may be a plurality of optical filters being arranged next to the image pickup device on the upstream side and having different wavelength characteristics.

4. The endoscope system according to claim 1, wherein the controller controls the light source, the variable spectroscopic device, and the image pickup device so that images of the fluorescent light in the plurality of wavelength bands and the light different in wavelength band from the fluorescent light are picked up before the image pickup device moves with respect to the object to be observed.

5. The endoscope system according to claim 1, wherein the controller controls the light source, the variable spectroscopic device, and the image pickup device so that images of the fluorescent light in the plurality of wavelength bands and the light different in wavelength band from the fluorescent light are picked up continuously.

6. The endoscope system according to claim 1, comprising an image arithmetic processing unit that performs arithmetic processing among a plurality of fluorescent images acquired by picking up images of the fluorescent light in the plurality of wavelength bands.

7. The endoscope system according to claim 6, comprising a display that displays images after having applied with the arithmetic processing by the image arithmetic processing unit.

8. The endoscope system according to claim 1, wherein the fluorescent light in the plurality of wavelength bands is generated by exiting a plurality of fluorescent substances by irradiation light in one or more wavelength bands.

9. The endoscope system according to claim 1, wherein at least one of the fluorescent light in the plurality of wavelength bands is fluorescent light in a wavelength band from red to near-infrared emitted by fluorescent agent combined with a specific substance existing in the interior of the object to be observed or fluorescent agent accumulated in the interior of the object to be observed being excited by the irradiation light.

10. The endoscope system according to claim 1, wherein light different in wavelength band from the fluorescent light is reflected light from the object to be observed in a visible band.

11. The endoscope system according to claim 1, wherein at least one of the fluorescent light in the plurality of wavelength bands is fluorescent light emitted from a substance originally existing in the object to be observed by being excited by the irradiation light.

12. The endoscope system according to claim 1, wherein the variable spectroscopic device has a first state which allows the fluorescent light in at least one wavelength band from fluorescent light emitted from the object to be observed to enter the image pickup device and a second state which prevent the fluorescent light of the corresponding wavelength band from entering the image pickup device.

13. The endoscope system according to claim 1, wherein the variable spectroscopic device has a first state which allows fluorescent light in a first wavelength band included in fluorescent light emitted from the object to be observed to enter the image pickup device and prevents fluorescent light in a second wavelength band different from the first wavelength band from entering the image pickup device, a second state which prevents the fluorescent light in the first wavelength band and the second wavelength band from entering the image pickup device, and a third state which prevents the fluorescent light in the first wavelength band from entering the image pickup device and allows the fluorescent light in the second wavelength band to enter the image pickup device.

14. The endoscope system according to claim 12, wherein the variable spectroscopic device includes a transmitting band common to the spectrum characteristics in all the states.

15. The endoscope system according to claim 14, wherein the common transmitting band includes at least part of a wavelength band from green to blue in a visible band including red, green, and blue.

16. The endoscope system according to claim 1, wherein the controller switches the plurality of types of irradiation light emitted from the light source in a time-sharing manner.

17. The endoscope system according to claim 1, wherein the controller performs switching of the irradiation light emitted from the light source and switching of the spectrum characteristics of the variable spectroscopic device.

18. The endoscope system according to claim 1, wherein the controller controls an exposure value of the image pickup device by adjusting light from the light source or adjusting the exposure of the image pickup device according to the switching of the irradiation light emitted from the light source.

19. The endoscope system according to claim 1, wherein the variable spectroscopic device includes optical members opposing to each other at a distance and the spectrum transmittance is varied by changing the distance between the optical members.

20. The endoscope system according to claim 10, wherein the reflected light includes a light-absorbing band of hemoglobin and is light having a wavelength in a band narrower than a band from green to blue included in a spectrum sensitivity band of the image pickup device including the respective bands of red, green and blue.

21. The endoscope system according to claim 1, wherein the light source is arranged outside the body cavity.

22. The endoscope system according to claim 18, wherein the exposure value is controlled on the basis of the intensity of at least one image acquired by the image pickup device.

23. The endoscope system according to claim 6, wherein the arithmetic processing is processing to standardize the intensity of other images by the intensity of at least one image acquired by the image pickup device.

24. The endoscope system according to claim 2, wherein the controller controls the light source and the image pickup device so that images of the fluorescent light in the plurality of wavelength bands and the light different in wavelength band from the fluorescent light are picked up before the image pickup device moves with respect to the object to be observed.

25. The endoscope system according to claim 2, wherein the controller controls the light source and the image pickup device so that images of the fluorescent light in the plurality of wavelength bands and the light different in wavelength band from the fluorescent light are picked up continuously.

26. The endoscope system according to claim 2, comprising the image arithmetic processing unit that performs the arithmetic processing among the plurality of fluorescent images acquired by picking up images of the fluorescent light in the plurality of wavelength bands.

27. The endoscope system according to claim 26, comprising the display that displays images after having applied with the arithmetic processing by the image arithmetic processing unit.

28. The endoscope system according to claim 2, wherein the fluorescent light in the plurality of wavelength bands is generated by exciting the plurality of fluorescent substances by irradiation light in one or more wavelength bands.

29. The endoscope system according to claim 2, wherein at least one of the fluorescent light in the plurality of wavelength bands is fluorescent light in the wavelength band from red to near-infrared emitted by fluorescent agent combined with a specific substance existing in the interior of the object to be observed or fluorescent agent accumulated in the interior of the object to be observed being excited by the irradiation light.

30. The endoscope system according to claim 2, wherein the light different in wavelength band from the fluorescent light is reflected light from the object to be observed in the visible band.

31. The endoscope system according to claim 2, wherein at least one of the fluorescent light in the plurality of wavelength bands is the fluorescent light emitted from the substance originally existing in the interior of the object to be observed by being excited by the irradiation light.

32. The endoscope system according to claim 13, wherein the variable spectroscopic device includes the transmitting band common to the spectrum characteristics in all the states.

33. The endoscope system according to claim 32, wherein the common transmitting band includes at least part of the wavelength band from green to blue in the visible band including red, green, and blue.

34. The endoscope system according to claim 2, wherein the controller controls the exposure value of the image pickup device by adjusting light from the light source or adjusting the exposure of the image pickup device according to the switching of the irradiation light emitted from the light source.

35. The endoscope system according to claim 30, wherein the reflected light includes the light-absorbing band of hemoglobin and is the light having a wavelength in a band narrower than a band from green to blue included in a spectrum sensitivity band of the image pickup device including the respective bands of red, green, and blue.

36. The endoscope system according to claim 2, wherein the light source is arranged outside the body cavity.

37. The endoscope system according to claim 34, wherein the exposure value is controlled on the basis of the intensity of at least one image acquired by the image pickup device.

38. The endoscope system according to claim 26, wherein the arithmetic processing is processing to standardize the intensity of other images by the intensity of at least one image acquired by the image pickup device.

39. An endoscope system that acquires images of an object to be observed in a body cavity of a living body by being introduced at least partly into the body cavity comprising:
irradiation light generating means that emits a plurality of types of irradiation light having different spectral characteristics and being radiated onto the object to be observed;
optical propagating means that propagates the irradiation light from the irradiation light generating means toward the object to be observed;
image pickup means which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light;
variable spectroscopic means which is arranged in an optical path between the image pickup device and the distal end of the portion to be inserted into the body cavity and is capable of changing the wavelength band of light entering the image pickup device from the object to be observed by varying the spectral characteristics thereof; and
control means that controls the irradiation light generating means, the variable spectroscopic means and the image pickup means so as to acquire an image of the fluorescent light in a plurality of the wavelength bands and of the light different in wavelength band from the fluorescent light at the same position in a time-sharing manner.

40. An endoscope system that acquires images of an object to be observed in a body cavity of a living body by being introduced at least partly into the body cavity comprising:
irradiation light generating means that emits a plurality of types of irradiation light having different spectral characteristics and being radiated onto the object to be observed;
optical propagating means that propagates the irradiation light from the irradiation light generating means toward the object to be observed;
image pickup means which is provided at a portion to be inserted into the body cavity and is capable of picking up images of fluorescent light in a plurality of wavelength bands radiated from the object to be observed and light different in wavelength band from the fluorescent light by irradiating the plurality of types of irradiation light;
spectrum forming means which is arranged in an optical path between the image pickup device and the distal end of the portion to be inserted into the body cavity and spatially forming spectrum of light incoming from the object to be observed into the image pickup device; and
controlling means that controls the irradiation light generating means, and the image pickup means so as to acquire an image of the fluorescent light in a plurality of the wavelength bands and of the light different in wavelength band from the fluorescent light substantially at the same time.
